(19) United States
(12) Patent Application Publication
(10) Pub. No.: US 2005/0225052 A1
(43) Pub. Date: Oct. 13, 2005

(54) Air car

(76) Inventor: Yoshioki Tomoyasu, Fujisawa-shi (JP)

Correspondence Address: Yoshioki Tomoyasu, 21-22 Mirokuji 3-chome, Fujisawa-shi, 251-0016, JP

(21) Appl. No.: 10/823,313

(22) Filed: Apr. 11, 2004

(51) Int. Cl. B60R 3/00

(52) U.S. Cl. 280/165

(57) ABSTRACT

The invention is directed to drive the motor car into the air with the lift force produced by the head wind caused by either engine or motor to rotate the blades of windmill equipped with on the roof thereof geared with the lever fence fitted with bores to be passed through by the air connected with the connecting rod to operate the hydraulic apparatus to produce and multiply the lift force accommodated inside the cover wing of which trailing edge is inclined to produce lift independently in the propulsive operation and with the thrust made by either engine or motor.

### FIELD OF THE INVENTION

The present invention is generally directed to providing the motor car with the lift force strong enough to drive in the air taking advantage of head wind generated by either engine or motor thereof.

### BACKGROUND OF THE INVENTION

On the background that there are a remarkable tendency for increasing the number of the motor car in the world, many problems on such as the grobal environment, air pollution, traffic jam and the like happen to appear. Therefore, it is required to solve the problems urgently.

### SUMMARY OF THE INVENTION

The invention is generally directed to provide the vehicle with the lift force for enabling to drive in the air by use of a hydraulic apparatus to multiply the lift force converted by the head wind caused by either engine or motor thereof without any additional energy sources involved, thus saving production as well as running costs and resulting at solving the problems of air pollution, traffic jam and accidents. The mechanism of the system of this invention is designed to operate said hydraulic apparatus installed inside of the cover wing over the roof thereof geared with the motion of a connecting rod connected with the lever fence fitted with bores guiding air flow to pass through to be fluctuated up and down in repeated operations subject to the rotating operation of the blades ejecting outwards from the shaft of the windmill equipped with the front roof thereof to be rotated by the force of head wind caused by the propulsive operation of either engine or turbine or motor thereof. In case where said lever fence connected with the connecting rod is designed to be fluctuated ups and downs continuously subject to the shift of said rotating blade of the windmill, it is possible to damp out the fluctuation of the lift force available for the vehicle driven in the air that the plural units of the hydraulic apparatus is situated being arranged either in parallel or lengthwise with different phase of blades of the windmill. On the other hand, the vehicle is designed to be handles with a control stick capable of driving in the air as well as on the ground with a plate attached on the side walls sharing the function of rudders and flaps just like the oar to the boat.

The test findings on the head wind against thrust of the motor car registered more than 80% of the initial air flow to be retrieved to apply the force to be delivered to the hydraulic apparatus in multiplying, in addition, the engine of small sized truck is converted into that of the aircraft accomodated with several passengers for commercial use, thus proving to provide sufficient propulsive force to the motor car in the air and the lift force available by the hydraulic apparatus is strong enough to hold up the motor car in the air in view of the fact that hydraulic apparatus driving crane is possible to lift the heavy bundle of metal bars, furthermore the lift force is given birth to the motor car while driving in high speed to an extent that the wheels thereof are lifted up to scarcely contact with the ground firmly. Thus it is easily understood that the system of the invention is most likely applicable to the actual use with less running as well as production costs and exhausting gases.

### BRIEF DESCRIPTION OF THE DRAWING

FIG. 1 is an example of a cross sectional side view of the air car in statistic situation.

FIG. 2 is an example of a cross sectional view of the detailed mechanism to operate the hydraulic apparatus by means of the head wind caused by either engine or motor.

### DETAILED DESCRIPTION OF THE INVENTION

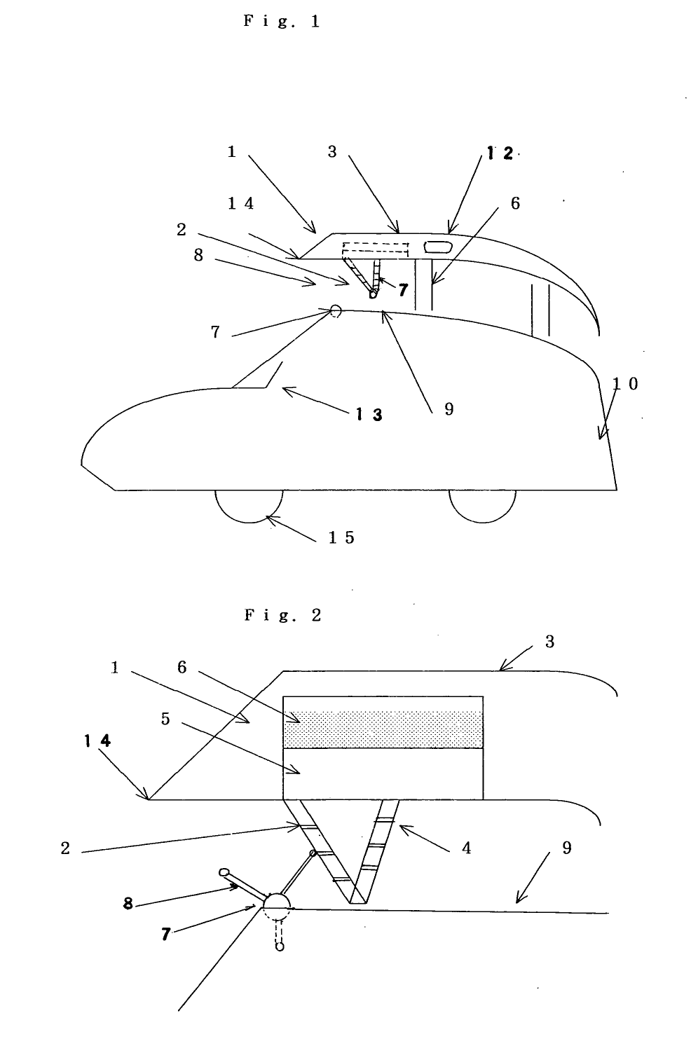

As shown FIG. 1 and FIG. 2, the air car is equipped with the hydraulic apparatus (1) accommodated inside a cover wing (3) propped over the roof (9) thereof consisting of the hydraulic cylinder (5) and the hydraulic oil (6) to convert the head wind caused by either engine (10) or motor of the motor car into lift force to be multiplied by the function thereof Said hydraulic apparatus (1) is designed to be operated by the connecting rod (4) geared with the motion of the lever fence (2) fitted with some bores guiding air flow to pass through and to be raised by blades (8) which are radially ejected outwards from the shaft of the windmill (7) rotated by the headwind thus eliminating the need for any electric appliance such as ordinary hydraulic apparatus, and available at considerable low cost. Said hydraulic apparatus (1) is designed to push upward said hydraulic cylinder (5) to deliver the force transmitted through the connecting rod (4) linked with the lever fence (2) to be raised by said blades (8) of the windmill (7) to be rotated by the variable force subject to the fluctuation subject to the phase of said blades (8) in rotating operation.

Whereas, in the event that the plural units of the hydraulic apparatus(1) are employed in arrangement either in parallel or in lengthwise with different phase of said blades (8) of said windmill (7), said hydraulic apparatus (1) are most possible to damp out these variation to keep providing the lift force continuously.

It is proved that the capability of the engine of the motor car is applicable to the air car in view of the fact that an engine of small truck is converted to a propeller driven engine for an aircraft with several passengers for the commercial use, in addition, the test findings assigned by us to an institute of a public laboratory registered more than 80% of the total wind power is retrieved in their wind dome. Therefore, the force of the head wind is strong enough to rotate said windmill (7) capable of driving the motor car in the air continuously.

1. Air car comprise a hydraulic apparatus accommodated in a cover wing propped over a roof of a motor car to produce lift force to be operated with a connecting rod geared with a lever fence fitted with bores guiding air flow to pass through and to be pushed to raise upwards with the rotating blades of a windmill equipped with a front roof of the vehicle to be rotated with head wind caused by either engine or motor.

2. Air car is designed to drive the motor car in the air with the lift force which is comverted from said head wind and multiplied by said hydraulic apparatus to be operated by the force of said head wind and thrust made by either engine or motor thereof with additional lift force produced by the angle of trailing edge of said cover wing inclined to produce in driving operation.

3. Air car is equipped with the windmill of which blades are radially ejected outwards from the shaft to be rotated by the head wind designed to push the fence lever connected with the connecting rod generating with either single unit or the plural units of the hydraulic cylinder capable of multiply the lift force produced by the force of said head wind. The invention is applicable to respective car connected in order to make avail for the lift force.

4. Air car allows the force produced by other energy source to operate said hydrualic apparatus to lift the car body perpendicularly, thus enabling to drive in the air without any head wind.

5. Air car is designed to employ the respective hydraulic apparatus at either container or car connected herewith to increase the lift force.
